(19) United States
(12) Patent Application Publication
(10) Pub. No.: US 2015/0062750 A1
(43) Pub. Date: Mar. 5, 2015

(54) ROTATING DEVICE

(71) Applicant: SAMSUNG ELECTRO-MECHANICS JAPAN ADVANCED TECHNOLOGY CO. LTD, Fujieda City (JP)

(72) Inventors: Akikazu IZUMI, Fujieda City (JP); Hiroshi MORIMOTO, Fujieda City (JP)

(73) Assignee: SAMSUNG ELECTRO-MECHANICS JAPAN ADVANCED TECHNOLOGY CO. LTD, Fujieda City (JP)

(21) Appl. No.: 14/470,454

(22) Filed: Aug. 27, 2014

(30) Foreign Application Priority Data
Aug. 30, 2013 (JP) 2013-178963

(51) Int. Cl. G11B 33/00; G11B 5/60

(52) U.S. Cl. CPC G11B 33/005; G11B 5/60
USPC 360/99.08

(57) ABSTRACT

A rotating device includes a stationary body, a rotating body formed with an opening encircling a rotation axis, a fluid dynamic bearing mechanism which supports the rotating body relative to the stationary body, and which has a portion at one end side fitted in and fixed to the opening, a support portion that protrudes from an outer circumference of the fluid dynamic bearing mechanism to support the rotating body, and an abutting portion provided at the rotating body so as to abut the support portion. The support portion includes a flange protruding outwardly in a radial direction from the outer circumference of the fluid dynamic bearing mechanism, and the abutting portion includes a step that is a recess which is formed along an open end of the opening and into which at least a part of the flange enters.

### BACKGROUND OF THE INVENTION

1. Field of the Invention

The present disclosure relates to a rotating device.

2. Description of the Related Art

As to disk drive devices like hard disk drives which are a kind of rotating devices, for example, a structure is disclosed in which a hub where multiple magnetic recording disks are to be mounted is supported by a sleeve encircling a fixed shaft, and is rotated together with the sleeve (see, for example, JP 2003-139129 A, JP 2010-261580 A, JP 2012-087867 A). In addition, a structure is also disclosed in which the hub is supported at an end of a freely rotatable shaft, and is rotated together with the shaft (see, for example, JP 2012-87861 A).

In the aforementioned structures, as to the hub and the sleeve, for example, one end of the sleeve is fixed to a hole of the hub by interference fitting, such as press-fitting or thermal insert. According to such interference fitting, however, there is a possibility that the sleeve is deformed, and the rotation of the hub and that of the magnetic recording disk mounted on the hub become unstable due to the deformation.

Hence, in order to suppress a deformation of the sleeve, the hole of the hub and the sleeve may be fixed by loose fit with the aid of a bond, etc. In this case, however, it is necessary to, for example, fit the sleeve in the hole of the hub and to maintain the bonding position by a jig, etc., until the bond is cured. Hence, there is a possibility that due to an attachment of the jig and a detachment thereof, the production efficiency decreases.

The present disclosure has been made in view of the aforementioned circumstances, and it is an objective of the present disclosure to provide a rotating device which can suppress a deformation of a component without a reduction of a production efficiency, and which can stably rotate a rotating body.

### SUMMARY OF THE INVENTION

To accomplish the above objective, a rotating device according to a first aspect includes: a stationary body; a rotating body formed with an opening encircling a rotation axis; a fluid dynamic bearing mechanism which supports the rotating body relative to the stationary body, and which has a portion at one end side fitted in and fixed to the opening; a support portion that protrudes from an outer circumference of the fluid dynamic bearing mechanism to support the rotating body; and an abutting portion provided at the rotating body so as to abut the support portion, in which: the support portion includes a flange protruding outwardly in a radial direction from the outer circumference of the fluid dynamic bearing mechanism; and the abutting portion includes a step that is a recess which is formed along an open end of the opening and into which at least a part of the flange enters.

To accomplish the above objective, a rotating device according to a second aspect of the present disclosure includes: a stationary body; a rotating body formed with an opening encircling a rotation axis; a fluid dynamic bearing mechanism which supports the rotating body relative to the stationary body, and which has a portion at one end side fitted in and fixed to the opening; a support portion that protrudes from an outer circumference of the fluid dynamic bearing mechanism to support the rotating body; and an abutting portion provided at the rotating body so as to abut the support portion, in which: the support portion includes a flange that protrudes outwardly in a radial direction from an outer circumference of the fluid dynamic bearing mechanism, and an annular portion extending from an outer circumference of the flange in an axial direction toward the rotating body; and the abutting portion includes an annular groove which is provided so as to surround the opening, and with which the annular portion is engaged.

To accomplish the above objective, a rotating device according to a third aspect of the present disclosure includes: a stationary body; a rotating body formed with an opening encircling a rotation axis; a fluid dynamic bearing mechanism which supports the rotating body relative to the stationary body, and which has a portion at one end side fitted in and fixed to the opening; a support portion that protrudes from an outer circumference of the fluid dynamic bearing mechanism to support the rotating body; and an abutting portion provided at the rotating body so as to abut the support portion, in which: the support portion includes a tapered supporting inclined face inclined relative to the rotation axis; and the abutting portion includes a tapered abutting inclined face which is formed on an inner circumference of the opening and which is inclined along the supporting inclined face.

### BRIEF DESCRIPTION OF THE DRAWINGS

FIG. 1 is a diagram illustrating an example general structure of a disk drive device according to a first embodiment;

FIG. 2 is a general cross-sectional view illustrating the disk drive device of the first embodiment;

FIG. 3 is a general cross-sectional view illustrating a disk drive device according to a second embodiment;

FIG. 4 is a general cross-sectional view illustrating a disk drive device according to a third embodiment; and

FIG. 5 is a general cross-sectional view illustrating a disk drive device according to a fourth embodiment.

### DETAILED DESCRIPTION OF THE PREFERRED EMBODIMENTS

Embodiments to carryout the present disclosure will be explained below with reference to the accompanying drawings. In the respective figures, the same component will be denoted by the same reference numeral, and the duplicated explanation thereof will be omitted. The dimension of a component in each figure is enlarged or scaled-down as needed to facilitate understanding. In addition, a part of a component not important to explain the embodiment will be omitted n each figure.

A disk drive device that is a rotating device according to an embodiment of the present disclosure allows, for example, magnetic recording disks recording data magnetically to be mounted, and rotates and drives the magnetic recording disks. Such a disk drive device is utilized as, for example, a hard disk drive.

### First Embodiment

### Structure of Disk Drive Device

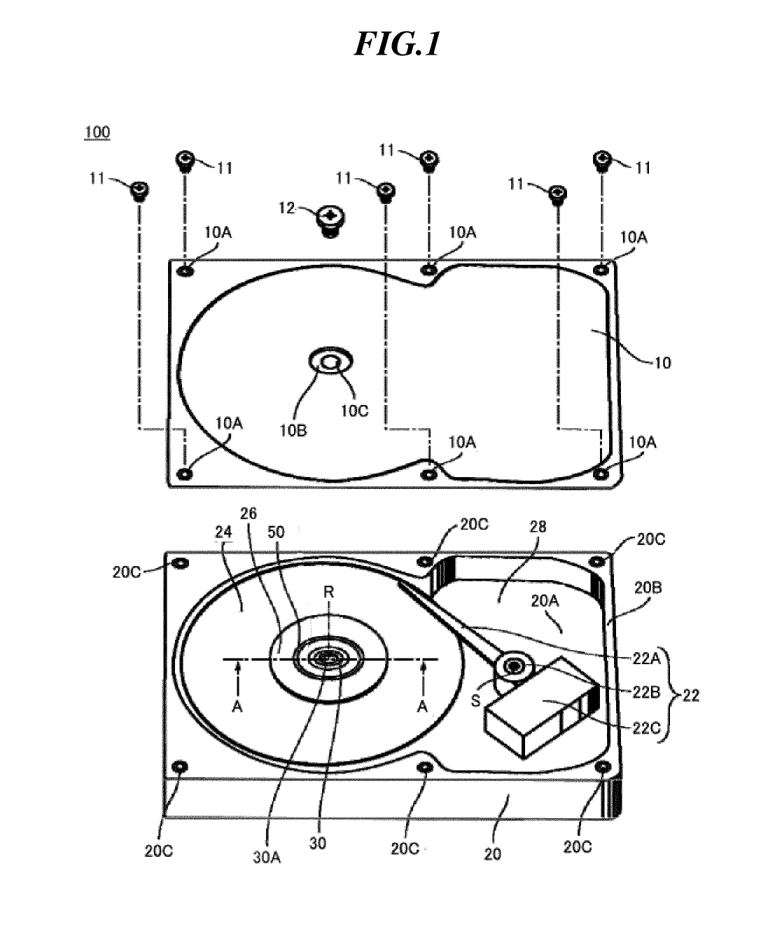

FIG. 1 illustrates an example structure of a disk drive device 100 according to this embodiment, and a general whole structure will be explained first.

The disk drive device 100 includes a top cover 10, a base 20, a data reader/writer 22, magnetic recording disks 24, a clamper 26, and a shaft 30.

In the following explanation, with the top cover 10 being attached to the base 20, the top-cover-10 side is defined as an upper side, while the base-20 side is defined as a lower side. In addition, a direction parallel to a rotation axis R of the magnetic recording disks 24 is defined as an axial direction, and an arbitrary direction passing through the rotation axis R on a plane perpendicular to the rotation axis R is defined as a radial direction. In the radial direction, a side distant from the rotation axis R is defined as an outer circumference side, while a side close to the rotation axis R is defined as an inner circumference side. Those notations are not intended to limit the posture of the disk drive device 100 when in use, and the disk drive device 100 can be used in any arbitrary posture.

(Top Cover)

The top cover 10 is a thin plate in a substantially rectangular shape, and includes a screw through-holes 10A provided in the circumference, a cover protrusion 10B protruding downwardly toward the base 20, and a center hole 10C provided in the center of the cover protrusion 10B. The cover protrusion 10B is provided around the rotation axis R.

The top cover 10 is formed in a predetermined shape by, for example, pressing an aluminum sheet or a steel sheet, and a surface process like plating may be performed on the top cover 10 to suppress a corrosion. The top cover 10 is fixed to an upper face of the base 20 by peripheral screws 11 fitted in the respective screw through-holes 10A. The top cover 10 and the base 20 are fixed together so as to air-tightly seal the interior of the disk drive device 100. A center screw 12 is fitted in the center hole 10C, and the center screw 12 is engaged with a retainer hole 30A of the shaft 30 fixed to the base 20.

(Base)

The base 20 includes a bottom plate 20A forming the bottom of the disk drive device 100, and an outer circumference wall 20B formed along the outer circumference of the bottom plate 20A so as to surround an area where the magnetic recording disks 24 are to be mounted. Screw holes 20C engaged with the respective peripheral screws 11 are provided in the upper face of the outer circumference wall 20B.

The top cover 10 is fixed to the upper face of the outer circumference wall 20B of the base 20 by the peripheral screws 11. A disk retaining space 28 defined by the bottom plate 20A of the base 20, the outer circumference wall 20B thereof, and the top cover 10 is air-tightly sealed and isolated from an external environment, and is filled with a clean gas like air having dusts, etc., eliminated. Hence, foreign materials like dusts are prevented from sticking to the magnetic recording disks 24, and a possibility of a false operation of the disk drive device 100 is reduced.

The base 20 is formed by die-casting of, for example, an aluminum alloy, but the material and the forming method are not limited to those examples. The base 20 may be formed by pressing a sheet metal of, for example, stainless-steel or aluminum. In the case of pressing, an emboss work may be performed so as to form convexities on the upper side of the base 20. When the emboss work is performed on the predetermined portion, a deformation of the base 20 can be suppressed.

In addition, the base 20 may have a surface process layer like nickel plating or a coating layer like an epoxy resin, and may be have the bottom plate 20A formed of equal to or greater than two laminated sheets. Still further, the base 20 may have a part formed of a resin.

(Magnetic Recording Disk)

The magnetic recording disk 24 is, for example, a 3.5-inch magnetic recording disk formed of an aluminum alloy and having a diameter of substantially 90 mm. An engagement hole formed at the center and having a diameter of, for example, 25 mm is engaged with the circumference of a hub 50. According to the disk drive device 100, for example, three to six magnetic recording disks 24 are to be mounted on the hub 50 and are rotated and driven. The multiple magnetic recording disks 24 are fixed to the hub 50 by the clamper 26 with spacers being present therebetween.

(Data Reader/Writer)

The data reader/writer 22 includes an unillustrated recording/playing head, a swing arm 22A, a pivot assembly 22B, and a voice coil motor 22C. The recoding/playing head is attached to the tip of the swing arm 22A, records data in the magnetic recording disk 24, or reads the data therefrom. The pivot assembly 22B supports the swing arm 22A in a swingable manner to the base 20 around a head rotating axis S. The voice coil motor 22C allows the swing arm 22A to swing around the head rotating axis S to move the recording/playing head to a desired location over the top face of the magnetic recording disk 24. The pivot assembly 22B and the voice coil motor 22C are configured by a conventionally well-known technology of controlling the position of a head.

<Structure of Bearing Mechanism>

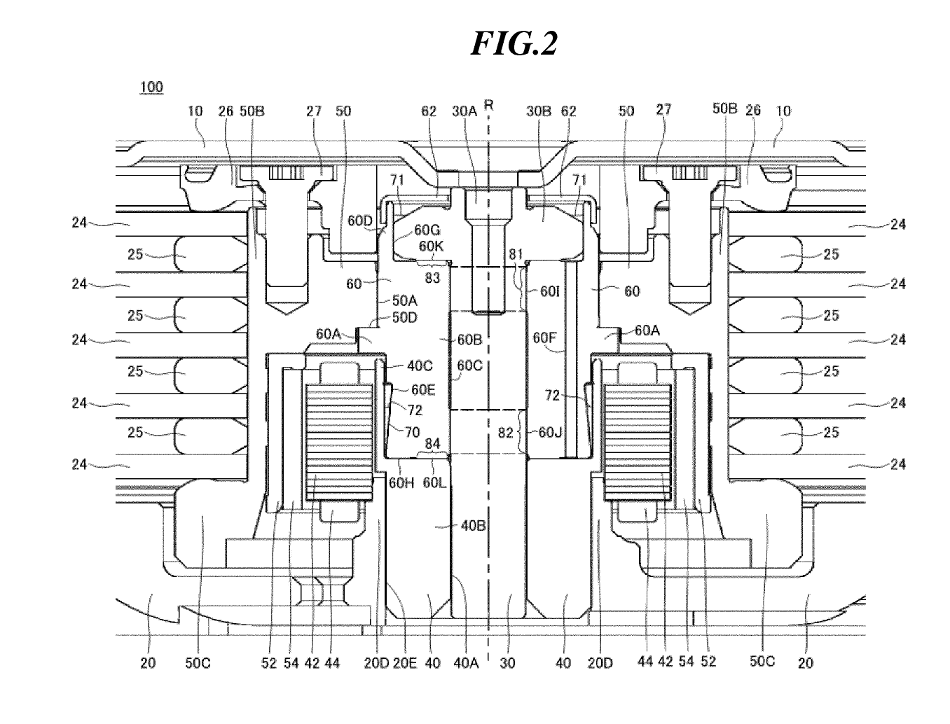

FIG. 2 is a cross-sectional view of the disk drive device 100 taken along a line A-A in FIG. 1, and is a general cross-sectional view illustrating an example bearing mechanism of the disk drive device 100.

The disk drive device 100 includes the base 20, the shaft 30, a housing 40, a stator core 42, coils 44, the hub 50, a yoke 52, a magnet 54, a sleeve 60, and a cap 62. The base 20, the shaft 30, the housing 40, the stator core 42, and the coils 44 form an example stationary body. In addition, the hub 50, the yoke 52, and the magnet 54 form an example rotating body, and the sleeve 60 is an example bearing body. Still further, the shaft 30 and the housing 40 form an example shaft body. The bearing body and the shaft body are rotatable relative to each other, and form a bearing unit.

In the disk drive device 100, a lubricant 70 is applied between the shaft 30 and the sleeve 60, and between the housing 40 and the sleeve 60, and the sleeve 60 is freely rotatable relative to the stationary body like the shaft 30 together with the hub 50 fixed to and supported by the sleeve 60.

(Base)

The base 20 includes a protruding portion 20D protruding from the bottom cylindrically around the rotation axis R as viewed from the top. The protruding portion 20D protrudes upwardly toward the hub 50 from the bottom, and the stator core 42 is fixed to the outer circumference of the protruding portion 20D. The base 20 is formed with a center hole 20E along the inner circumference of the protruding portion 20D around the rotation axis R, and the center hole 20E fixes and supports the housing 40.

The base 20 may have an inner area including the protruding portion 20D and an outer area encircling the inner area, the inner area and the outer area being formed as separate bodies. In this case, it is desirable that the inner area should be formed of a material having a higher Young's modulus than that of the material forming the outer area. In this case, the boundary between the inner area and the outer area is provided at, for example, the outer circumference side from the outer edge of the hub 50.

(Shaft)

The shaft 30 includes the retainer hole 30A and a top flange 30B at an upper-end side, and has the lower end fixed to a shaft hole 40A of the housing 40 by, for example, interference fitting. As to the interference fitting, for example, the shaft 30 is fitted in the shaft hole 40A by press-fitting or thermal insert. Alternatively, the shaft 30 is fitted by cooling fit of letting the shaft 30 cooled by a liquid nitrogen, fitted in the shaft hole 40A and returned to a normal temperature. In the interference fitting of the shaft 30 with the shaft hole 40A of the housing 40, bonding may be also applied.

The shaft 30 is formed in a substantially cylindrical shape by cutting or grinding of a ferrous material like stainless-steel, such as SUS 420 J2, SUS 430, or SUS 303. The shaft 30 may be quenched to increase the hardness, and the outer circumference and the lower face of the top flange 30B may be polished to improve the dimensional precision. In addition, the shaft 30 may be formed of other materials like a resin, or may be formed by other techniques, such as pressing or molding.

The retainer hole 30A is provided in the upper end of the shaft 30, and retains thereinside the center screw 12 that is a fastener holding the top cover 10. For example, the center screw 12 is engaged with a female screw formed in the retainer hole 30A, thereby being joined with the shaft 30.

The top flange 30B is provided at the upper-end side of the shaft 30, and is formed in an annular shape as viewed from the top. In this embodiment, the shaft 30 and the top flange 30B are formed integrally with each other, and may formed as separate pieces and joined together by, for example, bonding.

(Housing)

The housing 40 includes the shaft hole 40A into which the shaft 30 is fitted, a support portion 40B fixing and supporting the shaft 30, and an annular portion 40C protruding upwardly from the outer circumference of the support portion 40B and encircling the lower end of the sleeve 60.

The housing 40 has the support portion 40B and the annular portion 40C formed integrally with each other. Since both portions are integrated together, the manufacturing error of the housing 40 can be reduced, and a joining work can be omitted. In addition, a deformation of the housing 40 relative to a shock load can be suppressed. However, the housing 40 can be formed by joining multiple pieces in accordance with the application of the disk drive device 100 and the restriction over designing, etc.

The housing 40 is formed by cutting of a metal material like stainless-steel, such as SUS 430, or a brass. However, the housing 40 can be formed of other materials like a resin and may be formed by other techniques, such as pressing and molding in accordance with the application of the disk drive device 100 and the restriction over designing, etc.

(Stator Core)

The stator core 42 includes an annular portion, and, for example, 12 salient poles extending from the annular portion outwardly in the radial direction. The stator core 42 can be formed by, for example, laminating and caulking 5 to 30 magnetic steel sheets each having a thickness of, for example, 0.2 to 0.35 mm. An insulation coating, such as electrodeposition coating or powder coating, is applied to the surface of the stator core 42. Note that the stator core 42 may be a solid core formed by conjugating magnetic powders in a predetermined shape.

The stator core 42 is fixed and supported by the stationary body. In this embodiment, the stator core 42 has the lower end of the inner circumference of the annular portion joined with a step provided on the protruding portion 20D of the base 20 by press-fitting, bonding or a combination thereof. In addition, the inner circumference of the annular portion of the stator core 42 may be bonded and fixed to the outer circumference of the annular portion 40C of the housing 40. According to the structure in which the stator core 42 is fixed to both of the base 20 and the housing 40, the annular portion of the stator core 42 is fixed and supported with a wide area in the axial direction, and thus a vibration of the stator core 42 can be suppressed.

(Coil)

The coil 44 is formed by winding a conductor wire around each salient pole of the stator core 42 by a predetermined number of turns. The conductor wire is, for example, a core wire like soft copper having a surface coated with an insulation layer like an urethane resin. A lubrication substance to reduce the friction resistance is applied to the surface of the conductor wire. The lubrication substance is, for example, polyamide compound.

The coils 44 are electrically connected to the conductor wire of an unillustrated flexible printed circuit board provided on the upper face or the back face of the bottom plate 20A of the base 20. When drive currents are caused to flow through the coils 44 from an unillustrated drive circuit through the flexible printed circuit board, magnetic fields are generated along the salient poles.

(Hub)

The hub 50 includes a center hole 50A, a cylindrical portion 50B, a mount portion 50C, and a step portion 50D. The magnetic recording disks 24 are to be mounted on the mount portion 50C, and the sleeve 60 is fitted in the center hole 50A. Hence, the hub 50 is freely rotatable around the rotation axis R together with the sleeve 60.

The center hole 50A is a through-hole in the axial direction around the rotation axis R, and the upper end of the sleeve 60 is fitted therein through the lower opening. The cylindrical portion 50B is formed annularly at the outer circumference of the hub 50, and is engaged with the engagement hole of the magnetic recording disk 24. The mount portion 50C is formed annularly so as to protrude outwardly in the radial direction from the lower end of the cylindrical portion 50B, and the multiple magnetic recording disks 24 are mounted on the mount portion 50C with the spacers 25 being present therebetween. The magnetic recording disks 24 are held between the clamper 26 and the mount portion 50C, thereby being fixed to the cylindrical portion 50B with the spacers 25. The step 50D is provided annularly at the lower opening of the center hole 50A, and is formed as a step abutting a flange 60A of the sleeve 60 fitted in the center hole 50A to support the sleeve 60. When the lower face of the step 50D abuts and is engaged with the upper face of the flange 60A of the sleeve 60, the hub 50 and the sleeve 60 are fixed together with both components being positioned. That is, the hub 50 is formed so as to maintain the position of the bearing unit in the axial direction relative to the sleeve 60 by the weight of the hub 50.

The hub 50 is formed of a non-ferrous material like an aluminum alloy, a ferrous material like stainless-steel, or a resin material like LCP (Liquid Crystal Polymer), or, a composite material thereof. In addition, the hub 50 may have a surface layer like plating or coating. Such a surface layer suppresses a peeling of fine residues sticking to the processed face of the hub 50.

In this case, an airflow generating portion may be provided between the lower face of the mount portion 50C of the hub 50 and the base 20. In this case, airflow generating grooves in, for example, herringbone shape or spiral shape are formed in the lower face of the mount portion 50C of the hub 50 or the upper face of the base 20 facing the mount portion 50C. The airflow generating grooves are formed so as to generate airflow of directing a gas present between the mount portion 50C of the hub 50 and base 20 to the interior side when the hub 50 rotates. For example, according to such airflow generating grooves, a dispersion of the lubricant 70 toward the disk retaining space 28 can be suppressed.

(Spacer)

As explained above, the multiple magnetic recording disks 24 are fixed between the clamper 26 and the mount portion 50C of the hub 50 with the spacers 25 being present therebetween. The spacer 25 separates the two magnetic recording disks 24 in the axial direction. The spacer 25 is formed in a hollow ring shape, and has the hollow portion engaged with the cylindrical portion 50B of the hub 50. The spacer 25 is formed by, for example, cutting a ferrous material like stainless-steel SUS 303.

(Clamper)

The clamper 26 is formed in a substantially hollow disk shape, and is formed by, for example, cutting a ferrous material like stainless-steel SUS 303. The clamper 26 is fixed to the upper face of the hub 50 by, for example, a clamper screw 27, and the lower face of the circumference of the clamper 26 abuts the upper face of the uppermost magnetic recording disk 24, thereby fixing the magnetic recording disks 24 to the cylindrical portion 50B of the hub 50.

(Yoke)

The yoke 52 is formed in a substantially cylindrical shape around the rotation axis R, and is bonded to and fixed to the inner circumference of the cylindrical portion 50B of the hub 50. The yoke 52 is formed by pressing or cutting, etc., of a ferrous material with soft magnetism. In addition, plating or coating may be applied to the surface of the yoke 52. The magnet 54 is fixed to the inner circumference of the yoke 52.

(Magnet)

The magnet 54 is formed in a substantially cylindrical shape around the rotation axis R, and has the outer circumference fixed to the inner circumference of the yoke 52 by, for example, bonding. The magnet 54 is formed of, for example, a ferrite-based magnetic material or a rare-earth-material-based magnetic material, and contains a resin like polyamide as a binder. The magnet 54 may be formed of a lamination of, for example, a ferrite-based magnetic layer and a rare-earth-material-based magnetic layer.

The magnet 54 has, for example, 8 or 16 magnetic poles formed in the inner circumference in the circumferential direction, and those magnetic poles are provided so as to face the outer circumferences of the salient poles of the stator core 42 with a gap in the radial direction.

A surface layer like electrodeposition coating or spray coating is applied to the surface of the magnet 54. Such a surface layer suppresses an oxidization of the magnet 54 and a peeling of the surface.

(Sleeve)

The sleeve 60 is an annular member that retains at least a part of the shaft body including the shaft 30, the top flange 30B, and the housing 40 in a manner freely rotatable, and is sometimes referred to as a bearing body in the following explanation. The sleeve 60 encircles the upper-end portion of the shaft 30, and is freely rotatable relative to the shaft 30 and the housing 40 together with the hub 50 supported by and fixed to the sleeve 60.

The center hole 50A of the hub 50 has an internal diameter larger than an outer diameter of the portion of the sleeve 60 fitted in the center hole 50A, and the sleeve 60 is fitted in the center hole 50A of the hub 50 by loose fit. When the hub 50 and the sleeve 60 are joined by loose fit, in comparison with interference fitting, a deformation of the hub 50 and that of the sleeve 60 can be suppressed, thus making the operation of the disk drive device 100 stable.

Provided on the outer circumference of the sleeve 60 is the annular flange 60A protruding outwardly in the radial direction and abutting and being engaged with the step 50D provided along the lower open end of the center hole 50A of the hub 50. The sleeve 60 is inserted in the center hole 50A of the hub 50 from the upper end of the sleeve 60 until the flange 60A abuts and is engaged with the step 50D. A bond is applied to at least either one of the inner circumference of the center hole 50A of the hub 50 and the portion of the sleeve 60 fitted in the center hole 50A, and the hub 50 and the sleeve 60 are fixed together by bonding. Since the step 50D of the hub 50 and the flange 60A of the sleeve 60 abut and are engaged with each other, the hub 50 and the sleeve 60 can be maintained at predetermined positions until the bond is cured.

According to this embodiment, since the hub 50 and the sleeve 60 are fixed together by loose fitting and bonding, a deformation of the hub 50 and that of the sleeve 60, etc., can be suppressed. In addition, since the step 50D of the hub 50 and the flange 60A of the sleeve 60 abut and are engaged with each other, the hub 50 and the sleeve 60 are held at predetermined positions even if no jig to maintain the position of the hub 50 is utilized. Hence, in comparison with a case in which no step and no flange are provided and the hub 50 and the sleeve 60 are held at predetermined positions using a jig, etc., maintaining the position of the hub 50 until the bond is cured, attachment and detachment of the jig can be eliminated, and thus a reduction of the production efficiency can be avoided.

The shape of the step 50D of the hub 50 and that of the flange 60A of the sleeve 60 may be different shapes from those of this embodiment as long as the sleeve 60 can support the hub 50.

The sleeve 60 includes, in addition to the flange 60A, a shaft encircling portion 60B, a shaft hole 60C, a flange encircling portion 60D, a seal portion 60E, and a communication channel 60F.

The shaft encircling portion 60B encircles, in the axial direction from the upper face of the support portion 40B of the housing 40 to the lower end of the top flange 30B of the shaft 30, the shaft 30 fitted in the shaft hole 60C. The shaft 30 is fitted in the shaft hole 60C. The flange encircling portion 60D protrudes upwardly from the circumference of the upper end of the shaft encircling portion 60B, and encircles the top flange 30B of the shaft 30. The seal portion 60E is a tapered face provided in the outer circumference of the lower end side of the shaft encircling portion 60B, and seals the lubricant 70 with the annular portion 40C of the housing 40. The seal portion 60E is formed so as to increase the gap with the annular portion 40C of the housing 40 toward the upper space. The communication channel 60F causes a space between the top flange 30B and the upper face of the shaft encircling portion 60B and a space between the upper face of the support portion 40B of the housing 40 and the lower face of the shaft encircling portion 60B to be in communication with each other, and reduces a pressure difference applied to the lubricant 70 in an area where the lubricant 70 is present.

The sleeve 60 is formed by, for example, cutting and machining a metal like stainless-steel SUS 430 or brass. The sleeve 60 may have a surface layer formed by, for example, electroless nickel plating.

According to this embodiment, each component of the sleeve 60 are integrally formed, but each component may be formed separately and then joined together as needed. For example, the sleeve 60 may have an internal component retaining the shaft 30 and an external component joined with the hub 50, and the internal component and the external component may be formed separately and then joined together.

(Lubricant and Sealing Structure)

Predetermined gaps are formed between the shaft body and the bearing body so as to apply the lubricant. In this embodiment, the lubricant 70 is applied between the shaft 30 and the sleeve 60, between the housing 40 and the sleeve 60, and in the communication channel 60F of the sleeve 60. The lubricant 70 contains a base oil to which a fluorescent material is added. Hence, when the lubricant 70 leaks from the gap between the components, if light with a predetermined wavelength is emitted, such a leakage can be easily detected.

The top flange 30B has the upper-end side face tapered so as to increase a gap with the inner circumference of the flange encircling portion 60D toward the upper space. As a result, provided between the upper-end side face of the top flange 30B of the shaft 30 and the inner circumference of the flange encircling portion 60D of the sleeve 60 is a first tapered space increasing the gap in the radial direction toward the upper space. In the first tapered space, a first gas-liquid interface 71 of the lubricant 70 is formed. In the first tapered space between the upper-end side face of the top flange 30B and the inner circumference of the flange encircling portion 60D of the sleeve 60, force by a capillary phenomenon acts on the lubricant 70 toward the bottom direction where the gap becomes narrow, and thus the lubricant 70 is retained between the shaft 30 and the sleeve 60.

In a part of the inner circumference of the flange encircling portion 60D of the sleeve 60 facing the side face of the top flange 30B of the shaft 30, first pump seal grooves 60G in a herringbone shape, a spiral shape, etc., are formed. The first pump seal grooves 60G generate dynamic pressure to cause the lubricant 70 to flow downwardly, thereby suppressing a rise of the first gas-liquid interface 71 of the lubricant 70 and a leakage of the lubricant 70. The first pump seal grooves 60G may be formed in the side face of the top flange 30B of the shaft 30.

The seal portion 60E of the sleeve 60 is, as explained above, formed in a tapered shape increasing the gap with the inner circumference of the annular portion 40C of the housing 40 toward the upper space. As a result, provided between the inner circumference of the annular portion 40C of the housing 40 and the seal portion 60E of the sleeve 60 is a second tapered space increasing the gap in the radial direction toward the upper space. A second gas-liquid interface 72 of the lubricant 70 is formed in the second tapered space. In the second tapered space between the inner circumference of the annular portion 40C of the housing 40 and the seal portion 60E of the sleeve 60, force by a capillary phenomenon acts on the lubricant 70 toward the bottom direction where the gap becomes narrow, and thus the lubricant 70 is retained between the housing 40 and the sleeve 60.

In addition, provided in the outer circumference of the lower face of the shaft encircling portion 60B of the sleeve 60 are second pump seal grooves 60H formed in a herringbone shape or spiral shape, etc. The second pump seal grooves 60H generate dynamic pressure causing the lubricant 70 to flow to the internal side, thereby suppressing a rise of the second gas-liquid interface 72 of the lubricant 70 and a leakage of the lubricant 70. The second pump seal grooves 60H may be provided in the upper face of the support portion 40B of the housing 40.

(Cap)

The sleeve 60 is provided with the cap 62 in a substantially cylindrical shape having the circumference engaged with the outer circumference of the flange encircling portion 60D of the sleeve 60. The cap 62 covers the first gas-liquid interface 71 formed between the top flange 30B of the shaft 30 and the flange encircling portion 60D of the sleeve 60, and prevents the lubricant 70 from splashing in the device. The cap 62 is formed by, for example, cutting and machining of a ferrous material or a resin material.

(Dynamic Pressure Generating Portion)

At least either one of the shaft body and the bearing body is provided with radial dynamic pressure generating grooves that generate dynamic pressure to the lubricant. In this embodiment, between the outer circumference of the shaft 30 and the inner circumference of the shaft encircling portion 60B of the sleeve 60, a first radial dynamic pressure generating portion 81 and a second radial dynamic pressure generating portion 82 are formed at the upper end side of the shaft 30 and the lower end side thereof, respectively. The first radial dynamic pressure generating portion 81 and the second radial dynamic pressure generating portion 82 are provided so as to be spaced apart from each other in the axial direction.

Provided in the inner circumference of the shaft encircling portion 60B of the sleeve 60 at a location corresponding to the first radial dynamic pressure generating portion 81 are first radial dynamic pressure generating grooves 60I in a herringbone shape or spiral shape, etc. In addition, provided in the inner circumference of the shaft encircling portion 60B of the sleeve 60 at a location corresponding to the second radial dynamic pressure generating portion 82 are second radial dynamic pressure generating grooves 60J in a herringbone shape or spiral shape, etc. Either one of or both of the first radial dynamic pressure generating grooves 60I and the second radial dynamic pressure generating grooves 60J may be provided in the outer circumference of the shaft 30.

Thrust dynamic pressure generating grooves that generate dynamic pressure to the lubricant are provided in either one of the shaft body and the bearing body. In this embodiment, a first thrust dynamic pressure generating portion 83 is provided between the lower face of the top flange 30B of the shaft 30 and the upper face of the shaft encircling portion 60B of the sleeve 60. First thrust dynamic pressure generating grooves 60K in a herringbone shape or spiral shape are formed in the upper face of the shaft encircling portion 60B of the sleeve 60. The first thrust dynamic pressure generating grooves 60K may be provided in the lower face of the top flange 30B of the shaft 30.

In addition, a second thrust dynamic pressure generating portion 84 is provided between the upper face of the support portion 40B of the housing 40 and the lower face of the shaft encircling portion 60B of the sleeve 60. Second thrust dynamic pressure generating grooves 60L in a herringbone shape or spiral shape, etc., are provided in the lower face of the shaft encircling portion 60B of the sleeve 60 at the inner-circumference side. The second thrust dynamic pressure generating grooves 60L may be provided in the upper face of the support portion 40B of the housing 40.

When the sleeve 60 rotates together with the hub 50 relative to the shaft 30, the first and second radial dynamic pressure generating portions 81, 82, and the first and second thrust dynamic pressure generating portions 83, 84 generate respective dynamic pressures to the lubricant 70. The sleeve 60 is supported by the dynamic pressures to the lubricant 70 in the axial direction and the radial direction in a non-contact manner with the shaft 30 and the housing 40, and rotates.

The first and second radial dynamic pressure generating grooves 60I, 60J, and the first and second thrust dynamic pressure generating grooves 60K, 60L are formed by, for example, pressing, ball rolling, electro-chemical machining, and cutting and machining that controls the position of a cutting tool with a piezoelectric element, but may be individually formed through different techniques.

(Manufacturing Process)

Next, an explanation will be given of a manufacturing process of the disk drive device 100.

First, the lower end of the shaft 30 is fitted in the shaft hole 60C of the sleeve 60, the housing 40 is fixed to the lower end of the shaft 30, and the lubricant 70 is applied. Next, the cap 62 is fixed to the upper end of the sleeve 60. The shaft 30 and the housing 40, the sleeve 60 and the cap 62, and, the base 20 and the housing 40 are fixed by press-fitting, bonding or a combination thereof, respectively. As a result, a bearing unit is manufactured.

In addition, the yoke 52 and the magnet 54 are bonded and fixed to the lower face of the hub 50. Next, a bond like a curable resin is applied to at least either one of the inner circumference of the center hole 50A of the hub 50 and the outer circumference of the sleeve 60. Subsequently, until the flange 60A of the sleeve 60 abuts the step 50D of the hub 50, the sleeve 60 is inserted in the center hole 50A of the hub 50 from the upper end of the sleeve 60.

With the step 50D of the hub 50 and the flange 60A of the sleeve 60 abutting with each other and the hub 50 being supported by the sleeve 60, ultraviolet rays are emitted to the hub 50 and the sleeve 60. The bond applied to the respective components and the bond, etc., pushed out from the gap between the center hole 50A of the hub 50 and the outer circumference of the sleeve 60 are tentatively cured by emitted ultraviolet rays.

Furthermore, the support portion 40B of the housing 40 is bonded and fixed to the center hole 20E of the base 20 to which the stator core 42 and the coils 44 are bonded and fixed.

Subsequently, the disk drive device 100 are left in a high-temperature bath at a temperature of, for example, 80 to 100 degrees for one to three hours, and when the bond is permanently cured, the respective components are completely fixed.

The above-explained manufacturing process is merely an example, and the disk drive device 100 can be manufactured through different manufacturing processes. For example, at least one step in the insertion of the shaft 30, the fixing of the housing 40, the application of the lubricant 70, and the fixing of the cap 62 may be carried out after the sleeve 60 is bonded to the hub 50.

Still further, the disk drive device 100 is assembled with the magnetic recording disks 24, the clamper 26, and the data reader/writer 22, etc., and the top cover 10 is fixed to the upper face of the base 20. At this time, the disk retaining space 28 is filled with clean gas having dusts, etc., eliminated, and is air-tightly sealed.

After the above-explained processes, the disk drive device 100 is thus manufactured through predetermined performance inspection processes. The sequence of the above-explained processes can be changed as needed.

As explained above, according to the disk drive device 100 of the first embodiment, the hub 50 and the sleeve 60 are bonded and fixed by loose fit, and thus a deformation of the hub 50 and that of the sleeve 60 can be suppressed. In addition, since the hub 50 and the sleeve 60 are fixed with the step 50D of the hub 50 and the flange 60A of the sleeve 60 abutting and being engaged with each other, the positional precision of the hub 50 and the sleeve 60 can be maintained even if no jig, etc., to maintain the position of the hub 50 is utilized in the assembling. As explained above, a deformation of the hub 50 and that of the sleeve 60 are suppressed, and the positional precision thereof at the time of assembling are ensured without decreasing the production efficiency. Therefore, the disk drive device 100 that improves the operation stability can be provided.

### Second Embodiment

Next, an explanation will be given of a second embodiment of the present disclosure with reference to the drawings. The same structural component as that of the above-explained embodiment will be denoted by the same reference numeral, and the duplicated explanation thereof will be omitted.

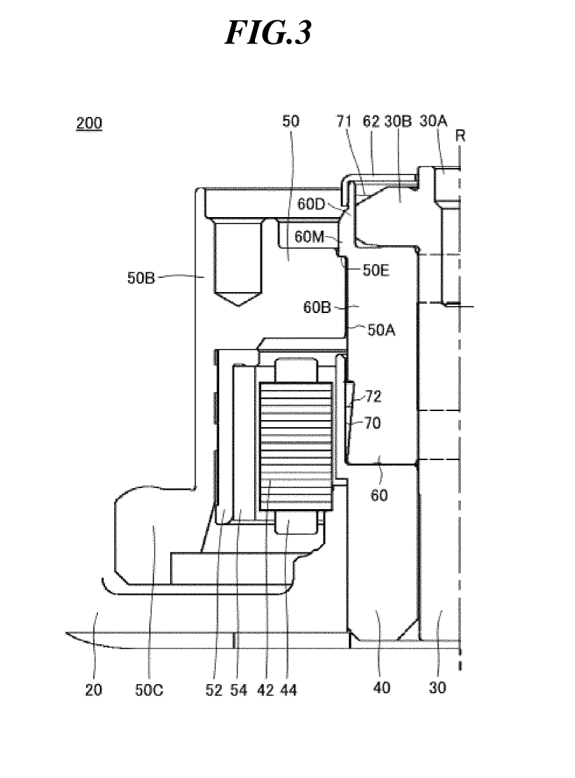

FIG. 3 is a general structural diagram illustrating an example disk drive device 200 of the second embodiment. In FIG. 3, the left part relative to the rotation axis R of the A-A cross section in FIG. 1 is illustrated, and the top cover 10, the magnetic recording disks 24, the spacer 25, and the clamper 26, etc., are omitted.

According to the disk drive device 200 of the second embodiment, the step 50E of the hub 50 is provided at the upper opening of the center hole 50A. In addition, a flange 60M that is a supporting portion of the sleeve 60 is provided so as to protrude outwardly in the radial direction from the outer circumference of the upper-end-side portion of the sleeve 60. The flange 60M is provided so as to protrude outwardly in the radial direction between the upper end of the shaft encircling portion 60B and the lower end portion of the flange encircling portion 60D in the outer circumference of the sleeve 60.

The inner diameter of the center hole 50A of the hub 50 is larger than the outer diameter of the portion of the sleeve 60 fitted in the center hole 50A of the hub 50, and the hub 50 and the sleeve 60 are fixed by loose fit. As to the hub 50 and the sleeve 60, first, a bond is applied to at least either one of the inner circumference of the center hole 50A of the hub 50 and the outer circumference of the sleeve 60. Next, the sleeve 60 is fitted in the center hole 50A of the hub 50 from the lower end of the sleeve 60 until the step 50E and the flange 60M abut and are engaged with each other. Hence, the hub 50 and the sleeve 60 are fixed at a predetermined position. Subsequently, the shaft 30 is fitted in the shaft hole 60C of the sleeve 60 from the lower end of the shaft 30, the housing 40 is fixed to the lower end of the shaft 30, and the lubricant 70 is applied. In addition, the cap 62 is fixed to the upper end of the sleeve 60.

As explained above, according to the second embodiment, the hub 50 and the sleeve 60 can be fixed with an excellent positional precision although no jig, etc., to maintain the position of the hub 50 is used. Therefore, the disk drive device 200 that has the operation stability improved can be provided without decreasing the production efficiency.

### Third Embodiment

Next, a third embodiment of the present disclosure will be explained with reference to the drawings. The same structural component as that of the above-explained embodiment will be denoted by the same reference numeral, and the duplicated explanation thereof will be omitted.

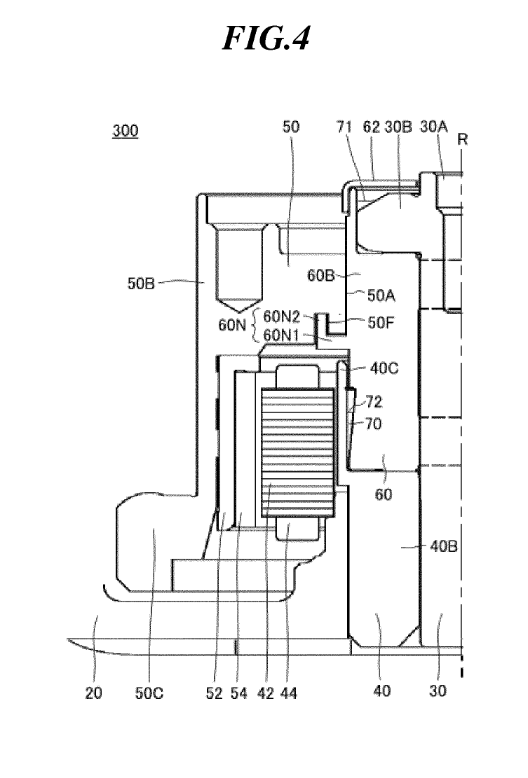

FIG. 4 is a general structural diagram illustrating an example disk drive device 300 of the third embodiment. In FIG. 4, the left part relative to the rotation axis R in the A-A cross section of FIG. 1 is illustrated, and the top cover 10, the magnetic recording disks 24, the spacer 25, the clamper 26, etc., are omitted.

According to the disk drive device 300 of the third embodiment, a support portion 60N protruding outwardly in the radial direction from the outer circumference of the sleeve 60 is provided on the upper part of the annular portion 40C of the housing 40 in the axial direction.

The support portion 60N of the sleeve 60 includes a flange 60N1 protruding outwardly in the radial direction from the outer circumference of the sleeve 60, and an annular portion 60N2 extending toward the hub 50 from the outer circumference of the flange 60N1 in the direction of the rotation axis. In addition, the hub 50 includes an annular groove 50F provided around the lower opening of the center hole 50A and engaged with the annular portion 60N2 of the support portion 60N.

The internal diameter of the center hole 50A of the hub 50 is larger than the outer diameter of the portion of the sleeve 60 fitted in the center hole 50A of the hub 50, and the hub 50 and the sleeve 60 are fixed together by loose fit. As to the hub 50 and the sleeve 60, first, a bond is applied to at least either one of the inner circumference of the center hole 50A of the hub 50 and the outer circumference of the sleeve 60. Next, the sleeve 60 is inserted in the center hole 50A of the hub 50 from the upper end of the sleeve 60 until the annular portion 60N2 of the support portion 60N is engaged and fitted with the annular groove 50F. Hence, the hub 50 and the sleeve 60 are fixed at a predetermined position.

As explained above, according to the third embodiment, the hub 50 and the sleeve 60 can be fixed with an excellent positional precision although no jig, etc., to maintain the position of the hub 50 is used. Therefore, the disk drive device 300 that has the operation stability improved can be provided without decreasing the production efficiency.

The support portion 60N may be provided at the upper-end side of the sleeve 60, and the annular portion 60N2 may extend downwardly from the outer circumference of the flange 60N1. In this case, the annular groove 50F to be engaged with the annular portion 60N2 is provided around the upper opening of the center hole 50A of the hub 50. According to such a structure, the sleeve 60 is inserted in the center hole 50A of the hub 50 from the lower end of the sleeve 60 until the annular portion 60N2 of the support portion 60N is engaged and fitted with the annular groove 50F. When the annular groove 50F and the annular portion 60N2 abut and are engaged with each other, the hub 50 and the sleeve 60 are fixed at a predetermined position.

### Fourth Embodiment

Next, an explanation will be given of a fourth embodiment of the present disclosure with reference to the drawings. The same structural component as that of the above-explained embodiment will be denoted by the same reference numeral, and the duplicated explanation thereof will be omitted.

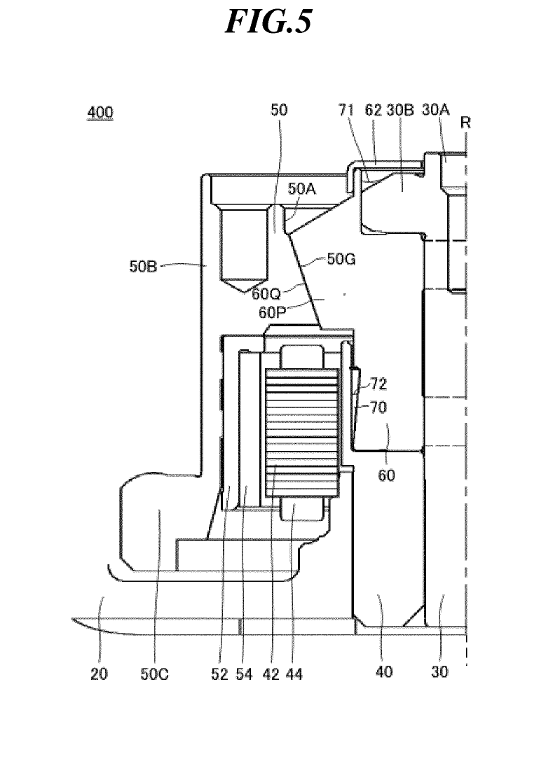

FIG. 5 is a general structural diagram of a disk drive device 400 of the fourth embodiment. In FIG. 5, the left part relative to the rotation axis R in the A-A cross section of FIG. 1 is illustrated, and the top cover 10, the magnetic recoding disks 24, the spacer 25, the clamper 26, etc., are omitted.

The sleeve 60 includes a support portion 60P protruding outwardly in the radial direction from the outer circumference of the sleeve 60. The support portion 60P includes a tapered supporting inclined face 60Q inclined relative to the rotation axis R. In addition, the center hole 50A of the hub 50 where the sleeve 60 is fitted includes an abutting inclined face 50G in a tapered shape inclined along the supporting inclined face 60Q.

As to the hub 50 and the sleeve 60, first, a bond is applied to at least either one of the abutting inclined face 50G of the hub 50 and the supporting inclined face 60Q of the sleeve 60. Next, the sleeve 60 is inserted in the center hole 50A of the hub 50 from the lower end of the sleeve 60 until the abutting inclined face 50G and the supporting inclined face 60Q abut and are engaged with each other. Hence, the hub 50 and the sleeve 60 are fixed at a predetermined position.

As explained above, according to the fourth embodiment, the hub 50 and the sleeve 60 can be fixed with an excellent positional precision although no jig, etc., to maintain the position of the hub 50 is used. Therefore, the disk drive device 400 that has the operation stability improved can be provided without decreasing the production efficiency.

The abutting inclined face 50G and the supporting inclined face 60Q may be provided so as to be inclined in opposite directions to those of this embodiment. In this case, as to the hub 50 and the sleeve 60, the sleeve 60 is inserted in the center hole 50A of the hub 50 from the upper end of the sleeve 60 until the abutting inclined face 50G and the supporting inclined face 60Q abut and are engaged with each other. Hence, the hub 50 and the sleeve 60 are fixed at a predetermined position.

Rotating devices according to the embodiments were explained above, but the present disclosure is not limited to the aforementioned embodiments, and permit various modifications and improvements without departing from the scope of the present disclosure.

What is claimed is:

1. A rotating device comprising:
a stationary body;
a rotating body formed with an opening encircling a rotation axis;
a fluid dynamic bearing mechanism which supports the rotating body relative to the stationary body, and which has a portion at one end side fitted in and fixed to the opening;
a support portion that protrudes from an outer circumference of the fluid dynamic bearing mechanism to support the rotating body; and
an abutting portion provided at the rotating body so as to abut the support portion,
wherein:
the support portion comprises a flange protruding outwardly in a radial direction from the outer circumference of the fluid dynamic bearing mechanism; and
the abutting portion comprises a step that is a recess which is formed along an open end of the opening and into which at least a part of the flange enters.

2. The rotating device according to claim 1, further comprising a top cover including a protruding area protruding in an axial direction around the rotation axis,
wherein the flange is provided outwardly in the radial direction relative to the protruding area.

3. The rotating device according to claim 1, wherein:
the fluid dynamic bearing mechanism comprises a bearing body fixed to the opening of the rotating body, and an encircling member which is fixed to the stationary body and which encircles the bearing body; and
the flange includes a portion extending in the radial direction right above an upper end of a portion of the encircling member encircling the bearing body.

4. The rotating device according to claim 1, wherein:
the stationary body comprises an annular stator core; and
the flange has an external end in the radial direction located within an area of the stator core in the radial direction.

5. The rotating device according to claim 1, wherein:
the rotating body comprises an annular magnet; and
the flange has an external end in the radial direction provided outside an area of the magnet in an axial direction.

6. The rotating device according to claim 1, wherein the flange includes an end face abutting an end face of the rotating body, and a side face forming a gap in the radial direction with a side face of the rotating body.

7. The rotating device according to claim 1, wherein:
the fluid dynamic bearing mechanism comprises a radial gap including a first radial dynamic pressure generating portion and a second radial dynamic pressure generating portion disposed so as to be distant from each other in an axial direction; and
the flange is located in an area of the radial gap excluding the first radial dynamic pressure generating portion and the second radial dynamic pressure generating portion in an axial direction.

8. A rotating device comprising:
a stationary body;
a rotating body formed with an opening encircling a rotation axis;
a fluid dynamic bearing mechanism which supports the rotating body relative to the stationary body, and which has a portion at one end side fitted in and fixed to the opening;
a support portion that protrudes from an outer circumference of the fluid dynamic bearing mechanism to support the rotating body; and
an abutting portion provided at the rotating body so as to abut the support portion,
wherein:
the support portion comprises a flange that protrudes outwardly in a radial direction from an outer circumference of the fluid dynamic bearing mechanism, and an annular portion extending from an outer circumference of the flange in an axial direction toward the rotating body; and
the abutting portion comprises an annular groove which is provided so as to surround the opening, and with which the annular portion is engaged.

9. The rotating device according to claim 8, wherein:
the fluid dynamic bearing mechanism comprises a bearing body fixed to the opening of the rotating body, and an encircling member which is fixed to the stationary body and which encircles the bearing body; and
the flange includes a portion extending in the radial direction right above an upper end of a portion of the encircling member encircling the bearing body.

10. The rotating device according to claim 8, wherein:
the stationary body comprises an annular stator core; and
the flange has an external end in the radial direction located within an area of the stator core in the radial direction.

11. The rotating device according to claim 8, wherein:
the rotating body comprises an annular magnet; and
the flange has an external end in the radial direction provided outside an area of the magnet in an axial direction.

12. The rotating device according to claim 8, wherein the annular portion includes an end face that faces an end face of the rotating body, and a side face forming a gap in the radial direction with a side face of the rotating body.

13. The rotating device according to claim 8, wherein:
the fluid dynamic bearing mechanism comprises a radial gap including a first radial dynamic pressure generating portion and a second radial dynamic pressure generating portion disposed so as to be distant from each other in an axial direction; and
the flange is located in an area of the radial gap excluding the first radial dynamic pressure generating portion and the second radial dynamic pressure generating portion in an axial direction.

14. The rotating device according to claim 8, wherein:
the rotating body comprises an annular wall extending toward the flange at an inner-circumference side of the annular groove; and
the annular portion includes a portion encircling the annular wall.

15. A rotating device comprising:
a stationary body;
a rotating body formed with an opening encircling a rotation axis;
a fluid dynamic bearing mechanism which supports the rotating body relative to the stationary body, and which has a portion at one end side fitted in and fixed to the opening;
a support portion that protrudes from an outer circumference of the fluid dynamic bearing mechanism to support the rotating body; and
an abutting portion provided at the rotating body so as to abut the support portion,
wherein:
the support portion comprises a tapered supporting inclined face inclined relative to the rotation axis; and
the abutting portion comprises a tapered abutting inclined face which is formed on an inner circumference of the opening and which is inclined along the supporting inclined face.

16. The rotating device according to claim 15, wherein:
the fluid dynamic bearing mechanism comprises a bearing body fixed to the rotating body; and
the supporting inclined face is formed on the bearing body.

17. The rotating device according to claim 15, wherein:
the fluid dynamic bearing mechanism comprises a bearing body fixed to the opening of the rotating body, and an encircling member which is fixed to the stationary body and which encircles the bearing body; and
the support portion includes a portion extending in the radial direction right above an upper end of a portion of the encircling member encircling the bearing body.

18. The rotating device according to claim 15, wherein:
the stationary body comprises an annular stator core; and
the supporting inclined face has an external end in the radial direction located within an area of the stator core in the radial direction.

19. The rotating device according to claim 15, wherein:
the rotating body comprises an annular magnet; and
the supporting inclined face has an external end in the radial direction provided outside an area of the magnet in an axial direction.

20. The rotating device according to claim 15, wherein:
the fluid dynamic bearing mechanism comprises a radial gap including a first radial dynamic pressure generating portion and a second radial dynamic pressure generating portion disposed so as to be distant from each other in an axial direction; and
the supporting inclined face includes a portion located in an area of the radial gap excluding the first radial dynamic pressure generating portion and the second radial dynamic pressure generating portion in an axial direction.
